(19) United States
(12) Patent Application Publication
(10) Pub. No.: US 2008/0141352 A1
(43) Pub. Date: Jun. 12, 2008

(54) SECURE PASSWORD DISTRIBUTION TO A CLIENT DEVICE OF A NETWORK

(75) Inventors: Brett L. Lindsley, Wheaton, IL (US); Thomas S. Messerges, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/608,966

(22) Filed: Dec. 11, 2006

(51) Int. Cl. H04L 9/32

(52) U.S. Cl. 726/6

(57) ABSTRACT

A password is securely distributed to a client device of a network by sending a first encrypted message from the client device to a server of the network, the first message comprising a nonce created by the client device, a username of the client device, and a network address of the client device, then sending a second message from the server to the network address of the client device, the second message comprising the nonce created by the client device, and a password created by the server. If the client device verifies that the nonce received from the server matches the nonce sent to the server, the password and username may be used to enable to client device to access information on the server. The first encrypted message may be an HTTPS message and the second message may be an SMS message.

### FIELD OF THE INVENTION

The present invention relates generally to communication between a client device and a server of a network.

### BACKGROUND

It is sometimes desirable to access on-line personal information associated with an account from a client device (such as a cellular handset, personal computer, PDA, or laptop, for example). An example is a customer's account at a merchandise store where the personal information may include the user's balance, current specialized sales, outstanding orders, etc. A common method to manage access to this information is for the client device (e.g., the user's portable device) to share, during an enrollment phase, some form of username and password (i.e., credentials) with a serving entity (e.g., a merchandise store's web server). The username and password can subsequently enable access to the user's on-line personal information, typically using the Hypertext Transfer Protocol (HTTP) with basic authentication over a secure channel, such as HTTP over a Secure Sockets Layer (HTTPS) or digest access authentication.

Managing access to personal information (referred to in general as ‘content’) from a client device (such as a mobile telephone, PDA, etc.) is very difficult. In general it requires an enrollment phase that comprises the creation of a username and password for the account and then a secure sharing of that information between the client and the serving entity. For security purposes, it is essential that the serving entity authenticate the enrolling client as the entity entitled to access the content. Likewise, it is essential that the client be certain that it is enrolling with the authentic server entity. That is, a solution with the property of mutual authentication is desired. Attacks where a rogue client poses as another client in order to gain access to that client's content and attacks where a rouge server poses as an authentic server in order to gain access to an authentic client's credentials should be infeasible. Thus, some method is needed to create securely and share credentials (e.g., a username/password pair) between a client device and a server so that these credentials can later be used to access content from the server, for example credentials to be used in HTTP basic authentication.

One approach is for the server entity to send a password and username to a particular cellular handset using Short Message Service (SMS). An SMS message containing the password would go from a network service management access point of the network to a handset. In this approach, the carrier provides assurance to the server entity that only the handset with a particular Mobile Station Integrated Services Digital Network Number (MSISDN) receives the password. A disadvantage of this approach is that the sender address information in an SMS message can be easily spoofed (i.e., it is relatively easy for someone to send an SMS message that conveys a false sender address). The contents of an SMS message are usually protected (via encryption) against eavesdropping during over-the-air transmissions between network access points (such as a cellular base site) and handsets; however a client cannot robustly authenticate a received SMS message as originating from the server entity indicated in the message. Thus, mutual authentication is not achieved and the client cannot be assured that the received password and username are authentic.

Another approach is for the client entity to send a password and username to a particular server entity digitally via Small Message Service (SMS) or verbally via a phone call. Again, problems arise because of the ease of spoofing sender address information in such an SMS message or, in the case of a phone call, the lack of security with caller ID (i.e., caller IDs can also be spoofed). The server cannot be assured that the received password and username are authentic.

E-mail and SMS are also becoming popular for activities such as account activation. Account activation is generally performed only once and is not used to reference information.

Thus, in all of these approaches mutual authentication and the goal of securely sharing a password and username are not achieved. Further, manual intervention by the user at the client is required to confirm that the password and username are received and accepted. An approach is still needed where a client's credentials are shared with a server and mutual authentication is achieved without relying on the authenticity of easily faked information, such as a caller ID or a sender address in an SMS message.

Another related technology is used in applications that manage E-mail distribution lists, where a person can unsubscribe to some service. In this case the server creates a nonce (a random symbol) and encodes it in a URL which is delivered via e-mail. This type of system only provides single direction authentication (the service can authenticate the client) but does not provide authentication in the other direction (there is no way for the client to authenticate the sender's e-mail address). Thus, although the server can verify the unsubscribe request is valid, the client cannot prove the received request is actually from the desired server. This makes single-direction authentication susceptible to “phishing” attacks where “look-alike” messages are sent to various clients in the hope someone will trigger the URL.

Finally, a public-key approach could be used to achieve mutual authentication and set up a secure channel for communicating username and password information. In this case, the server and client would each be assigned a unique private key and a public-key certificate. Such a system however would require a new public-key infrastructure, which would be very expensive to deploy, reuse of an existing public-key infrastructure. Reuse of an existing infrastructure would need to overcome technical and business issues such as new licensing and compliance requirements.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary message sequence diagram for password distribution with mutual authentication, consistent with some embodiments of the invention.

FIG. 2 is an exemplary system for secure password distribution, consistent with some embodiments of the invention.

FIG. 3 is a flow chart of a method for secure password distribution, consistent with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to password distribution to client devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element that is preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of password distribution described herein. The non-processor circuits may include, but are not limited to, a radio receiver, a radio transmitter, signal drivers, clock circuits, power source circuits, and user input devices. As such, these functions may be interpreted as a method to perform password distribution to client devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It is sometimes desirable to access on-line personal information associated with an account from a client device (such as a cellular handset, personal computer, PDA, or laptop, for example). An example is a customer's account at a merchandise store where the personal information may include the user's balance, current specialized sales, outstanding orders, etc. A common method to manage access to this information is for the client device (e.g., the user's portable device) to share, during an enrollment phase, some form of username and password (i.e., credentials) with a serving entity (e.g., a merchandise store's web server). The username and password can subsequently enable access to the user's on-line personal information, typically using the Hypertext Transfer Protocol (HTTP) with basic authentication over a secure channel, such as HTTP over a Secure Sockets Layer (HTTPS) or digest access authentication.

Thus, some method is needed to securely create and share credentials (e.g., a username/password pair) between a handset and a server so that these credentials can later be used to access content from the server, for example credentials to be used in HTTP basic authentication.

The present invention relates to the creation and sharing of credentials, such as a username/password pair, between a client device and a server so that these credentials can later be used to access content (personal information, for example) from the server. The credentials could be used in HTTP basic authentication, for example. In general, the client device itself cannot create the username and password because this would require a secure method to transfer them to the business. That is, the business would need to determine the authenticity of these credentials. This is a difficult task to solve, given the lack of end-to-end communication security (e.g., SMS is sender address can be faked), without the use of an expensive public-key infrastructure. Additionally, the business itself cannot create the username and password because it would require a secure method to transfer them to the handset. That is, the handset would need to determine the authenticity of these credentials, which is also difficult for the same reasons (e.g., insecure SMS or an expensive infrastructure). Thus, some method is needed to create a username and password pair securely for use on a client device. In one embodiment of the present invention, the client device creates the username, but the business creates the password. In this approach, the password is communicated securely to the client device. In order to provide secure password distribution, it is assumed the carrier is a trusted entity.

One challenge in authenticating the handset is that caller identification (caller ID) information is not secure. For example, it is relatively easy for someone to place a call that conveys a false caller ID. In addition, the sender address of an SMS message can be faked, although the contents of an SMS message are usually protected (via encryption) against eavesdropping during over-the-air transmissions between network access points (e.g., a cellular base site) and handsets.

To create a username/password pair securely, it is necessary to perform mutual authentication, that is, the client device user needs to ensure the business can prove its identity, and the business needs to confirm the requesting handset identity.

The present invention allows a username/password pair to be created automatically without user intervention.

In designing a security approach, considerations must be made regarding the asset being protected (i.e., the value of the asset), the vulnerabilities of this asset, the potential threats and attacks against these vulnerabilities, and the risks associated with these threats and attacks (e.g., the probability of an attack). For example, the content being accessed may be personal information rather than financial information. Personal information such as account information, customer discount information, order status, etc. may be less important to protect than information for a financial application such as bank account numbers or a bank password and username, etc.

The present invention assumes that the carrier is a trusted entity and is not going to allow the security to be circumvented. It should be noted that for situations with greater risks and higher-valued assets, such as with a financial application, the carrier may not be trusted by the financial institution. The password and username conveyed in this invention can be vulnerable to a malicious or negligent carrier; therefore in this invention, it is assumed that the carrier is trusted by the server entity to not allow such vulnerabilities to occur.

The protocol includes two basic operations. The first operation is an “enrollment” operation, in which a client device associates its network address and a username with a password. The network address may be a telephone number of a cellular telephone, for example. The second operation is a request for content using the username and password.

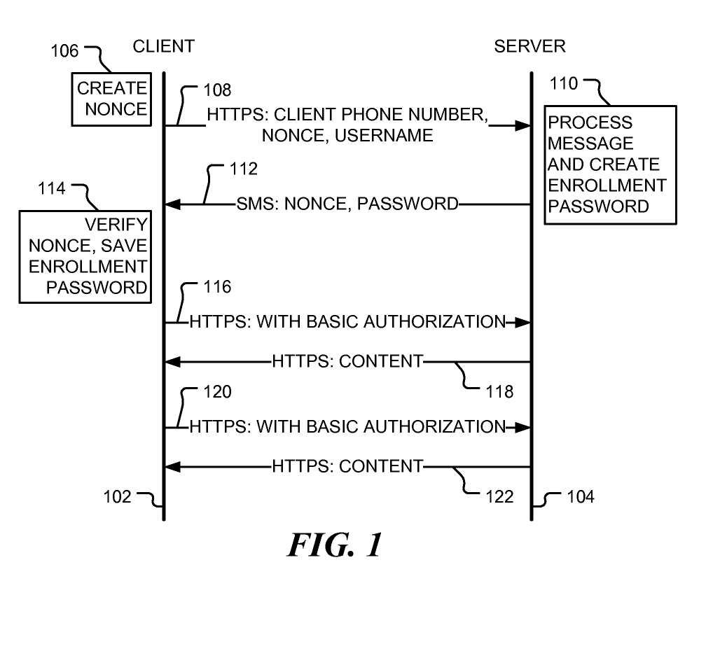

FIG. 1 is an exemplary message sequence diagram for password distribution with mutual authentication, and shows a timeline 102 for a client device (the ‘client’) and a timeline 104 for a business (the ‘server’). Referring to FIG. 1, the client creates a nonce (a random or unpredictable symbol) at 106 and, at 108, sends the nonce, together with its telephone number (or other network address) and a username to the business server using a secure transfer process, such as HTTPS. The transfer is secure, since the data is encrypted, so this information can be decrypted by the business server, but is kept private from any ‘man-in-the middle’ eavesdropper. At 110, the business will process the message received at 108. For example, the business may perform some checks of this message by querying a database to ensure the enrollment information received (e.g., the phone number or other network address) corresponds to a legitimate user that exists in the database and has not already completed an enrollment. Also, at 110, the business creates a password and, at 112, sends the password and nonce back to the client device using the telephone number (or other network address) specified in the first message. The nonce and password may be sent using a short message service (SMS). When the handset receives the password and nonce, it verifies at 114 that the nonce is the nonce that was created at 106. If the first nonce (sent by the client) matches the second nonce (received from the server), the password is saved on the handset with an “access” username for this specific business. Thus, the client associates the password with the access username if the first nonce is the same as the second nonce.

An “access username” is a username that can be used by the server entity to identify the client entity uniquely. For example an access username could be derived from the initial username sent in 108 and the client phone number (or other network address). Alternatively, the access username could be the same username as sent during 108, as long as this username was chosen in a way to ensure that it could be used to uniquely identify the client to the server entity. For example, the username in 108 might be a random value of sufficient length that it would be highly unlikely for another client to have already used it. In some embodiments, the user may select a username and the user working through the client may negotiate with the server entity in order to arrive at a suitably unique username. For example, if the username sent at 108 was already used by another client, then the server would need to inform the client to select a different username.

Once the client saves the access username and password, the “enrollment” process is completed. Only one SMS message is required. One purpose of this SMS message is to ensure that the client identified in the first HTTPS message has service via the telephone number indicated in the message sent at 108. Another purpose of the SMS is to ensure that the password is delivered only to the device identified with the telephone number indicated in the message sent at 108. For example, if an HTTPS response (to the original HTTPS request) were used to send the return password and nonce rather than an SMS, then an attacker could enroll with a fake telephone number.

To access content associated with the telephone number of this handset, the client device sets up an HTTPS connection to the business at 116 using the access username and password obtained in the enrollment process. At 118, the handset then receives personal content associated with this telephone number, again using HTTPS. It should be noted that HTTP may be used instead of HTTPS if a decrease in the security strength is acceptable.

Additional access may be obtained at a later time, without the need to enroll again. For example, the client device sets up a second HTTPS connection to the business at 120 using the username and password obtained in the enrollment process. At 120, the handset receives personal content associated with this telephone number, again using HTTPS.

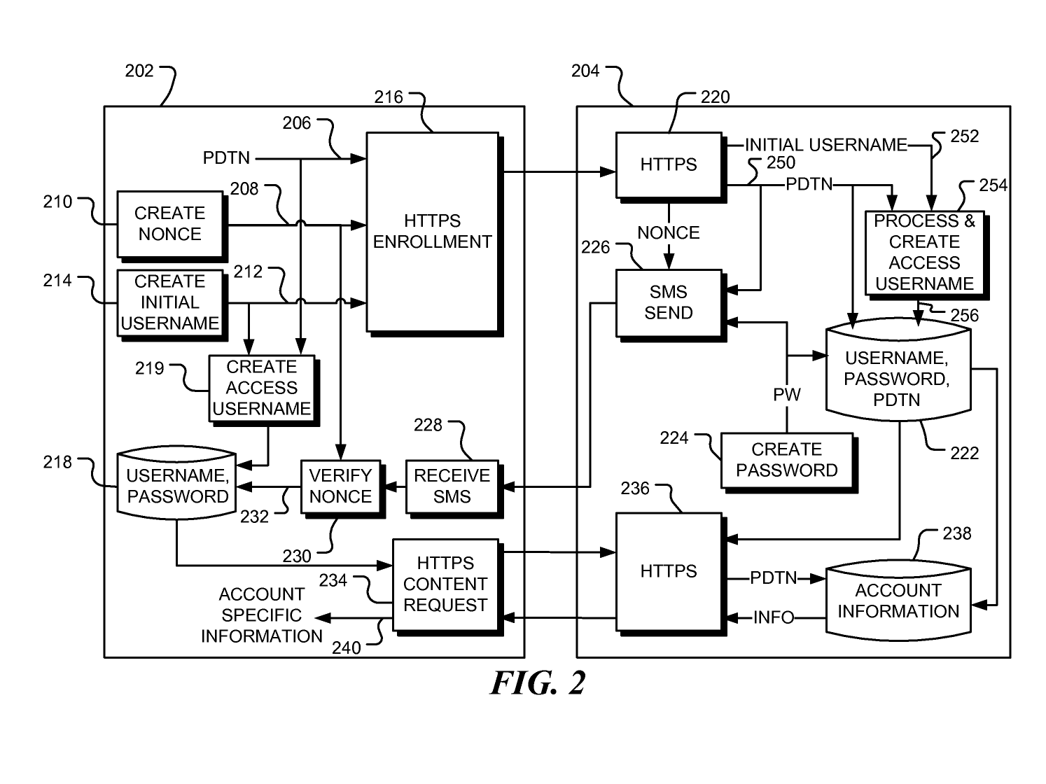

An exemplary system for implementing the message sequence is shown in FIG. 2. The system comprises a client device 202, such as a cellular telephone handset, PDA, portable computer, personal computer or the like, and a server 204 operated by a business entity or other information provider. The client device telephone number (PDTN) 206 or other network address, together with a nonce 208 created by nonce creation module 210 and a username 212 created by module 214 are passed to an HTTPS transfer module 216 and also stored in a memory or database 218. Module 214 may create the username on its own, for example, a random username, or may work with the user, for example via a graphical user interface, to select an appropriate user name. The HTTPS module 216 of the client device 202 sends the PDTN, nonce and username to an HTPPS module 220 of the server 204. The initial username 252 and the client device telephone number 250 are processed (e.g., the server may perform some checks of this data by querying databases 222 or 238 to ensure that this data corresponds to a legitimate user that exists in the database and has not already completed an enrollment) and then used in module 254 to create an access username 256. The access username 256 and client device telephone number (PDTN) 250 are stored in a database or memory 222. A password module 224 creates a password to be associated with the access username and stores the password (or, as would be apparent to one skilled in the art, stores a hash of the password and salt data) in the database 222. The password and nonce are used to compose a message that is sent by message module 226 to the client device 202. The message may be an SMS message or other message. The message is sent to the client device 202 having the telephone number received via HTTPS. The handset receives the message in module 228 and verifies in module 230 that the nonce is the same nonce that was sent. If the nonces match, a unique access username is deterministically created by access username creation module 219. For example the access username could be created from the client device telephone number 206 and the initial username 212 and stored in database 218. Alternatively, the access username could be the same username created by module 214, as long as this username was chosen in a way to ensure that it could be used to uniquely identify the client to the server entity.

When the client device 202 wants to retrieve personal content associated with the telephone number, the client device 202 makes an HTTPS connection from HTTPS module 234 using basic authentication with the stored access username and password. The HTTPS modules 216 and 234 may be the same module. Also, digest access authentication rather than basic authentication may be used. The server 204 receives the authentication information through the HTTPS module 236 and looks up the access username and password (or password hash) in the database 222. The HTTPS modules 220 and 236 may be the same module. The matching username/password pair is also associated with the telephone number (PDTN) and the PDTN is used to look up the account information in a database 238. The account specific information is then returned to the client device 202. The client device 202 receives the account specific information 240 via the HTTPS module 234.

The approach described above with reference to FIGS. 1 and 2 assumes that the carrier is to be trusted. This means, for example, that the carrier will deliver SMS messages to the stated recipient. Even if the carrier delivers the SMS to someone else or keeps it to himself (i.e., the carrier has been compromised), there is no security issue as long as the username is secure (it is sent via a transfer in a separate 108 that is secured end-to-end between the client and server). If the username is secure (i.e., kept private and contains sufficient entropy) then the recipient of the SMS message will only have the password for the account and cannot gain access. Additionally, it is assumed that the carrier is sufficiently trustworthy and will not mount an “active” man-in-the-middle attack. That is, an adversarial carrier could have generated the original HTTPS with a username of his choosing. Upon receipt of this HTTPS from the carrier, the business would activate the account with this carrier-chosen username and send back an SMS message with the nonce and password. The carrier would intercept this return SMS message, and then have the password and username for the victim's account.

The approach does not depend solely on caller ID or the SMS source telephone number being authentic.

The approach is particularly useful for account-based information tied to a telephone number of a telephone handset. This information may include items such as account balance, preferred customer information, outstanding orders, etc.

Security is strengthened since a strong secure password (for example, a non-dictionary expression) is automatically created by the business server. The password is created without the need for the user to intervene, thereby preventing the user from inadvertently divulging the password and simplifying the user's experience by not requiring the user to create or maintain passwords.

It is known that SMS messages may be spoofed (i.e., a recipient cannot be certain of a message's origin), but a spoofed message attack is prevented in the above approach. For example, an adversary can send its telephone number to a business that appears to originate from a potential victim's telephone. However, this causes the business to respond with an SMS message containing the password to the victim's telephone rather than the adversary's telephone. Since it would be difficult for the adversary to intercept and decrypt this response SMS message, he cannot learn the victim's password. Additionally, the victim's telephone would discard the received message since there was no request and no associated nonce.

The SMS message is encrypted by the carrier, so the returned password and nonce are secured against eavesdropping.

The handset generated nonce allows automatic protection against ‘phishing’ attacks, since received passwords that were not requested can be automatically discarded if a received nonce does not match a handset generated nonce.

The password is associated with the client device rather than the user, so additional user authentication may be needed for some applications. Techniques for user authentication, such as use of personal identification numbers or biometrics, are well known to those of ordinary skill in the art and have been applied to protecting other information such as sensitive documents, pictures, addresses, etc.

In a further embodiment, an out-of-band delivery of an extra password from the business to handset is used to satisfy applications that may need end-to-end security. This avoids having to trust the carrier. While this approach is likely to be more costly, it provides increased security.

In some embodiments, the passwords are managed using the HTTP REST (resource state transfer) protocol. For example the HTTP POST verb on the enrollment URL may be used to create the initial password. The body (or URL query string) contains the handset telephone number, nonce and username. The HTTP DELETE verb with username/password credentials in basic authentication on the enrollment URL may be used to delete a password. The HTTP UPDATE verb with username/password credentials in basic authentication on the enrollment URL may be used to request a new password. The HTTP GET verb with username/password credentials in basic authentication on the enrollment URL may be used to request a current password.

It is noted that in the event the client device is lost or stolen, the invention has the same level of security as any other application on the device. One simple resolution to this issue is to use a lock on the client device such that the client device cannot be used unless the personal identification number (PIN) or other security input (fingerprint etc.) is entered to unlock it first.

The username used in the HTTP authentication (called an “access username”) should be unique between all handsets. Since the handset phone numbers are unique but publicly visible, and the initial username is not visible but may not be unique, creating an access username as a function of the initial username (212 in FIG. 2) and the handset phone number (206) provides an access username that is both unique and not visible. A simple method for creating the access username is to concatenate the phone number to the end of the username. In one embodiment of the invention, the server appends the telephone number (240) to the initial username (242) submitted in the enrollment request to create the access username (226). This operation is known by the handset such that when the handset receives the password, the handset concatenates its own phone number (206) to the initial username (212) to create the access username/password pair (219). For example, a handset could create the username “Tom” with phone number 15558881212 and sends it to the business to request a password. The business creates a password and sends it back to the handset. The business associates the generated password with the username Tom15558881212. When the handset receives the password, the handset creates the username Tom15558881212 and saves it with the password. The expression Tom15558881212 is then used as the username for HTTP basic authentication. The username and telephone number may be combined in other ways to create a unique access username. One skilled in the art may use hashing functions, etc. to create more sophisticated access username, so long as the handset 219 and the server 254 are both in agreement on the method to create the access username from the initial username and the handset phone number. Another requirement is that the access username is chosen in a way that it can be used to identify the client uniquely to the server entity. A different username can be used with each server entity, or the same username can be used across all server entities.

The initial username is created on the handset (214). This username can be generated automatically and does not need to be exposed to the user. Any arbitrary collection of symbols can be used.

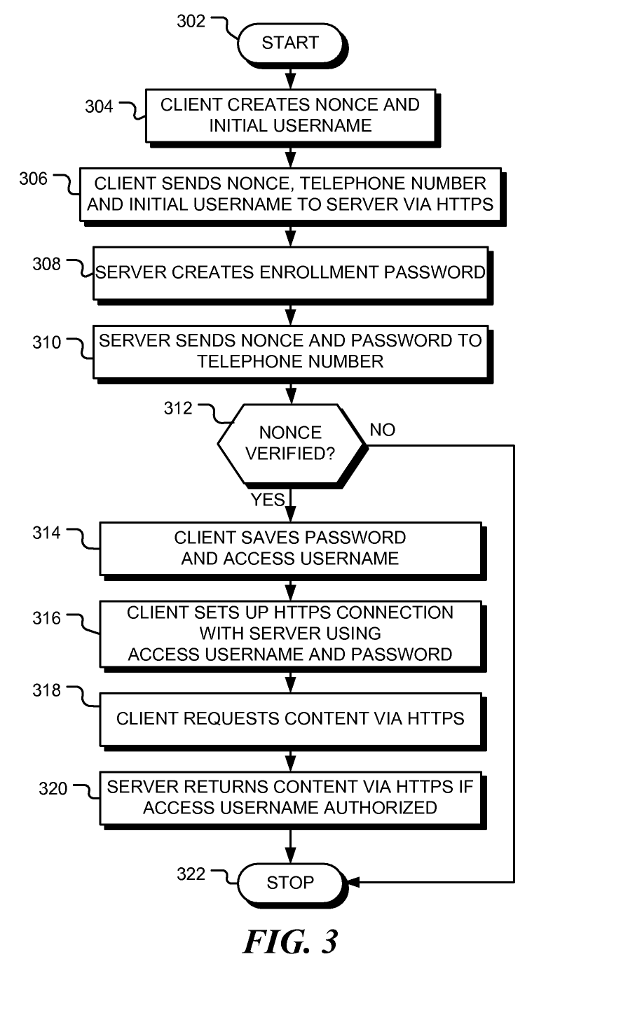

FIG. 3 is a flow chart of an exemplary method for password distribution using mutual authentication. Referring to FIG. 3, following start block 302, the client creates a nonce (a random symbol) and an initial username (or accesses an already created initial username) at block 304. At block 306 the client sends the nonce, together with the client's telephone number (or other network address) and the initial username to the business server using a secure transfer process, such as HTTPS. A non-secure transfer process (e.g., HTTP) may be used if the system is willing to tolerate a reduction in security strength (i.e., the information may be intercepted and read and the client does not authenticate the server). At block 308, the business server creates an enrollment password. At block 310, the server sends the password and nonce back to the client using the telephone number specified in the first message. The nonce and password may be sent using a short message service (SMS), for example. When the client receives the password and nonce, it determines at decision block 312, if the nonce is the same nonce that was created at 304. If the nonces match, as depicted by the positive branch from decision block 312, the password is saved on the handset with the access username for this specific business at block 314. The access username is created as a function of the initial username created in 304 and the telephone number. This completes the “enrollment” process. If the nonces do not match, or if no password request was made, the password is discarded and the process terminates at block 322, as depicted by the negative branch from decision block 312. Only one SMS message is required for the enrollment process. To access content associated with the phone number of this handset, the client sets up an HTTPS connection to the business at block 316 using the access username and password obtained in the enrollment process. At block 318, client requests content from the server using HTTPS and at block 320, the client receives the content associated with its telephone number, again using HTTPS. A non-secure connection using HTTP may be used if a reduction in security strength is acceptable. No SMSs are needed for regular content access (318, 320). The process terminates at block 322.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for password distribution in a network comprising a client and a server, the method comprising:
the client creating a first nonce;
the client sending the first nonce, an initial username, and a network address of the client to the server;
the client receiving a second nonce and a password from the server; and
the client associating the password with an access username if the first nonce is the same as the second nonce.

2. A method in accordance with claim 1, wherein the access username is dependent upon the initial username.

3. A method in accordance with claim 1, further comprising:
the client creating the initial username; and
the client creating the access username.

4. A method in accordance with claim 1, wherein the client sends the first nonce, the initial username and the network address to the server using a secure transfer.

5. A method in accordance with claim 1, further comprising:
the server receiving the first nonce, the initial username, and the network address;
the server creating the password; and
the server sending the second nonce and the password to the client at the specified network address,
wherein the second nonce is equal to the received first nonce.

6. A method in accordance with claim 5, wherein the server sends the password and the second nonce using a messaging system.

7. A method in accordance with claim 1, wherein the client comprises a portable telephone handset and the network address comprises a telephone number.

8. A portable device comprising:
a nonce creation module operable to create a first nonce;
a transfer module, operable to send to send the first nonce, an initial username and a network address of the portable device to a network server;
a message module operable to receive a second nonce and a password from the network server;
a nonce verification module operable compare the first nonce and the second nonce;
an access username creation module, operable to create an access username dependent upon the network address and the initial username;
a memory operable to store the access username and the password if the first nonce is the same as the second nonce.

9. A portable device in accordance with claim 8, further comprising an initial username creation module operable to create the initial username.

10. A portable device in accordance with claim 8, wherein the portable device comprises a telephone handset and the network address comprises a telephone number of the telephone handset.

11. A portable device in accordance with claim 8, wherein the message module comprises a Small Message Service (SMS) module.

12. A portable device in accordance with claim 8, wherein the transfer module comprises a HyperText Transfer Protocol (HTTP) module.

13. A sequence of messages for distributing a password to a client device of a network, the sequence comprising:
a first message sent from the client device to a server of the network, the first message comprising:
a nonce created by the client device;
an initial username; and
a network address of the client device; and
a second message sent from the server to the network address of the client device, the second message comprising:
the nonce created by the client device; and
a password created by the server.

14. A sequence of messages in accordance with claim 13, wherein the first message comprises a HyperText Transfer Protocol (HTTP) message.

15. A sequence of messages in accordance with claim 13, wherein the first message comprises a HyperText Transfer Protocol (HTTP) message sent over a Secure Sockets Layer (SSL).

16. A sequence of messages in accordance with claim 13, wherein the second message is sent using a Short Message Service (SMS).

17. A sequence of messages in accordance with claim 13, further comprising:
a third message from the client device to the server of the network, the third message comprising an information request; and
a fourth message from the server of the network to the client device, the fourth message comprising information.

18. A sequence of messages in accordance with claim 17, wherein the third message from the client device to the server comprises an access username and the password.

19. A sequence of messages in accordance with claim 17, wherein the third and fourth messages comprise HyperText Transfer Protocol (HTTP) messages sent over a Secure Sockets Layer (SSL).

20. A sequence of messages in accordance with claim 19, wherein the access username is dependent on the initial username.
